(19) United States
(12) Patent Application Publication
(10) Pub. No.: US 2017/0049055 A1
(43) Pub. Date: Feb. 23, 2017

(54) Tomato Catcher

(71) Applicant: Barbara K. Newman, Pinckney, MI (US)

(72) Inventor: Barbara K. Newman, Pinckney, MI (US)

(21) Appl. No.: 14/671,882

(22) Filed: Mar. 27, 2015

Related U.S. Application Data
(60) Provisional application No. 61/967,878, filed on Mar. 27, 2014.

(51) Int. Cl. A01D 46/26; A01D 45/00

(52) U.S. Cl. CPC A01D 46/26; A01D 45/006; A01D 45/008; A01D 2046/262

(57) ABSTRACT

A tomato catcher device having an outer rectangular plastic frame and an inner ultra-violet resistant netting with a rectangular cut-out in the center to allow a tomato or cucumber plant to grow up and through. The center rectangle cut-out is surrounded by flanges that rest against the plant to help shield the plant's produce from falling through the center net hole and onto the ground, thereby preventing the produce from rotting.

### REFERENCES CITED

### Referenced by

U.S. Patent Documents

| | | |
|---|---|---|
| 4,348,831 | Sep. 14, 1982 | Michael Chambers |
| 5,848,522 | Dec. 15, 1998 | Andrew Gary Coviello, Jr. |
| 7,003,913 | Feb. 28, 2006 | Dudley Smith |

### BACKGROUND OF THE INVENTION

This invention relates to the general field of plant growing devices and more specifically to a device to prevent tomato and cucumber plant produce from falling to the ground and thereby preventing produce spoilage. This device will prolong the life of the produce harvest by several days by allowing the produce to lay 4 inches or more above the soil and have 360 degree air ventilation.

In comparing this device to other inventions, the advantages of the present invention include, without limitation, the following: A “Vegetable And Fruit Saver” invented by Andrew Coviello Jr., U.S. Pat. No. 5,848,522, proposed an enclosure to surround a plant and urge the produce to the stem of the plant where a shield awaits surrounding the stem of the plant to hold the produce. While this method may keep the produce off the ground, it can accumulate produce at the base of the plant, putting pressure on the harvested fruits and decay if not promptly collected. Whereas the Tomato Catcher catches and allows the produce to remain in place where they fall on a horizontal netting platform 4 inches or more above the soil, thus allowing ample air circulation at the stem of the plant while keeping the produce from rotting in the soil where they would naturally fall from the vine.

With the Tomato Catcher device, tomatoes or cucumbers are dropped on the Tomato Catcher's netting and have 360 degree air ventilation as they are suspended four inches above the ground and are not in contact with soil, bacteria, or mold, allowing the produce to remain as clean as if they were still on the vine. Another similar invention, the Vegetable Cradle, U.S. Pat. No. 7,003,913 B1 dated Feb. 28, 2006, by Dudley Smith, measures approximately 4 inches wide, and approximately 9 inches in length with legs to support the platform so that it is only 1 inch off the ground. This is significantly smaller than the average tomato plant. In contrast, the Tomato Catcher measures 36×36 inches and is large enough to be able to catch nearly all the produce that fall from the plant. The Tomato Catcher not only prevents the produce from falling onto the soil but it also allows the plant and lower branches to rest at least 4 inches up from the soil and on top of the mesh allowing for better air circulation around the base of the plant and through the branches, thus helping to prevent crown rot, various bacteria, mold, and fungi from attacking the plant and tomatoes.

### SUMMARY OF THE INVENTION

In broad embodiment, the present invention is a device designed to aid in preventing harvested tomatoes and/or cucumbers or other produce from falling to the ground and, thereby, rotting.

The devise has an outer rectangular plastic frame and an inner ultra-violet resistant netting with a rectangular cut-out in the center so as to allow a tomato or cucumber plant to grow up and through. The center rectangular cut-out is surrounded by flanges which rest against the plant to help shield the produce from falling through the center hole and onto the ground, thereby preventing the produce from rotting.

To add a Tomato Catcher to a mature plant, simply locate a side with the thick black edging, cut both the center white utility tie and up through the same row to the rectangle in the center, assuring to stay in the middle of the same row. Next, carefully slide the Tomato Catcher over and around the mature plant, then rejoin the two sides of the black netting with the enclosed black utility ties spacing them approximately every 1½ inches, and use two of the remaining white utility ties to reattach both sides of the cut netting back onto the PVC frame. The Tomato Catcher can be re-used year after year.

Prominent features of this invention will become more apparent from the following drawings and detailed description which follows.

### BRIEF DESCRIPTION OF THE DRAWINGS

FIG. 1 is a perspective view of the tomato catcher device;

FIG. 2 is a perspective close-up view of the center rectangle, illustrating the ½ inch tab to help keep tomatoes from falling through the center hole;

FIG. 3 is a perspective view of the frame of the tomato catcher device;

FIG. 4 is a perspective view of the ultra violet resistant hardware netting to be attached to the frame of the tomato catcher device;

FIG. 5 is a perspective close-up view of the netting and center rectangle of FIG. 4;

FIG. 6 is a perspective topside view and underside view of the tomato catcher device;

FIG. 7 is a perspective side-view of the tomato catcher device;

FIG. 8 is a perspective view of the tomato catcher net being cut and opened to allow for placement around a mature tomato plant;

FIG. 9 is a perspective view of the closure of the tomato catcher net as it would look after having been placed around a mature tomato plant;

FIG. 10 are perspective views of the top and underside of the tomato catcher device as it would look after being placed around a mature tomato plant;

FIG. 11 is a view of the constructed tomato catcher device being placed over and around a mature tomato plant;

FIG. 12 is a view of the constructed tomato catcher device being opened to accommodate an extremely large plant;

FIG. 13 is a perspective view of the constructed tomato catcher device being slid into place around the stem of a mature tomato plant;

FIG. 14 is a perspective close-up view of the center rectangle cut-out after being placed on and around a mature tomato plant;

FIG. 15 is a perspective view of the tomato catcher at work;

FIG. 16 is a perspective view of the device representing 5 tomato catchers which are attached and stackable;

FIG. 17 is a perspective view of 5 tomato catcher devices attached and hinged for side by side use;

FIG. 18 is a perspective close-up view of the net hinging of the side by side attached tomato catcher device;

FIG. 19 is a perspective view of the multi-attached tomato catcher devices.

FIG. 20 is a perspective view of a tomato catcher device placed over a potted plant.

### DESCRIPTION OF THE PREFERRED EMBODIMENTS

While the foregoing background description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

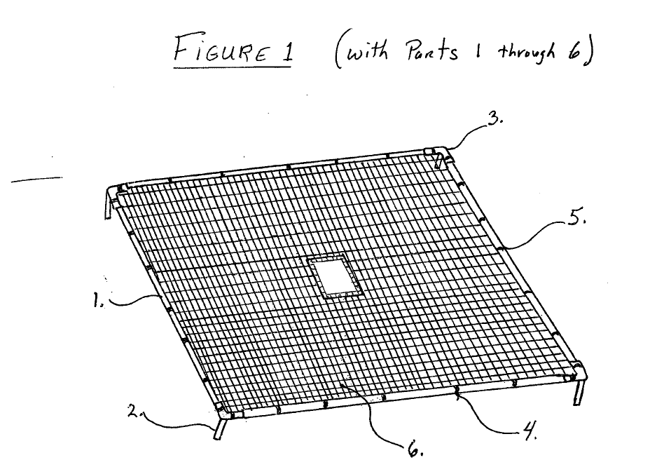

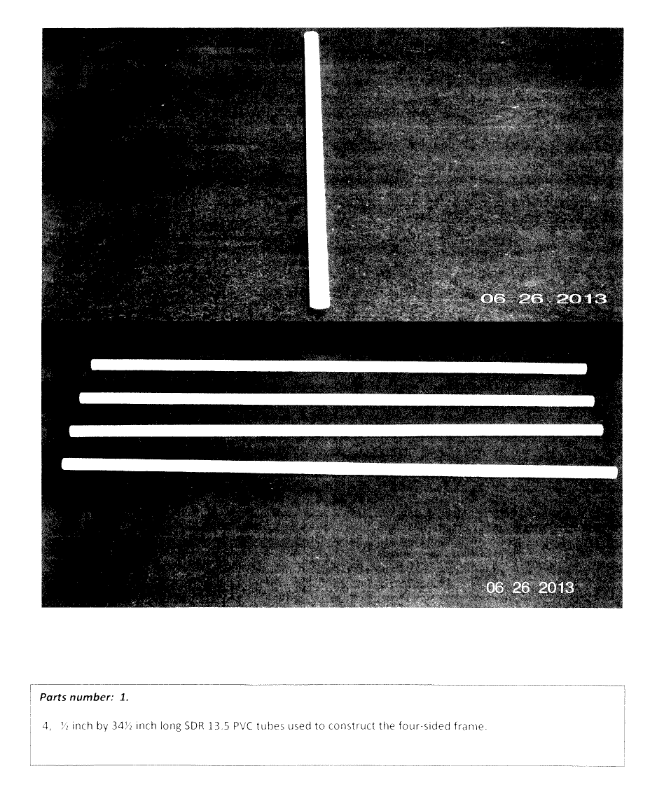

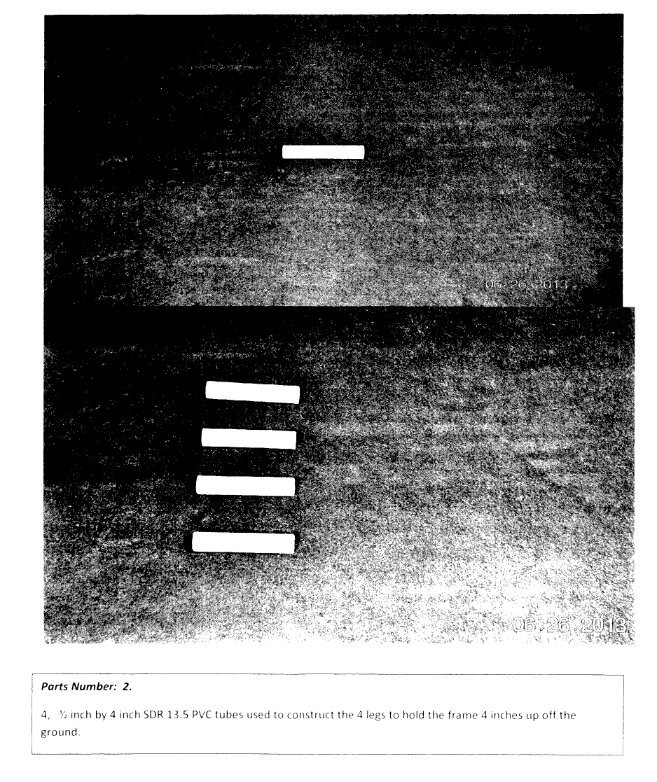

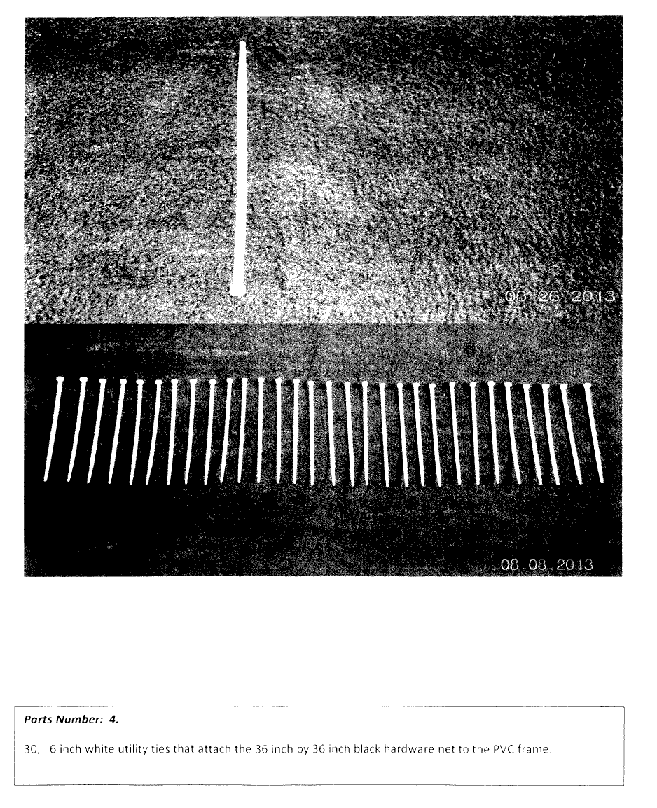

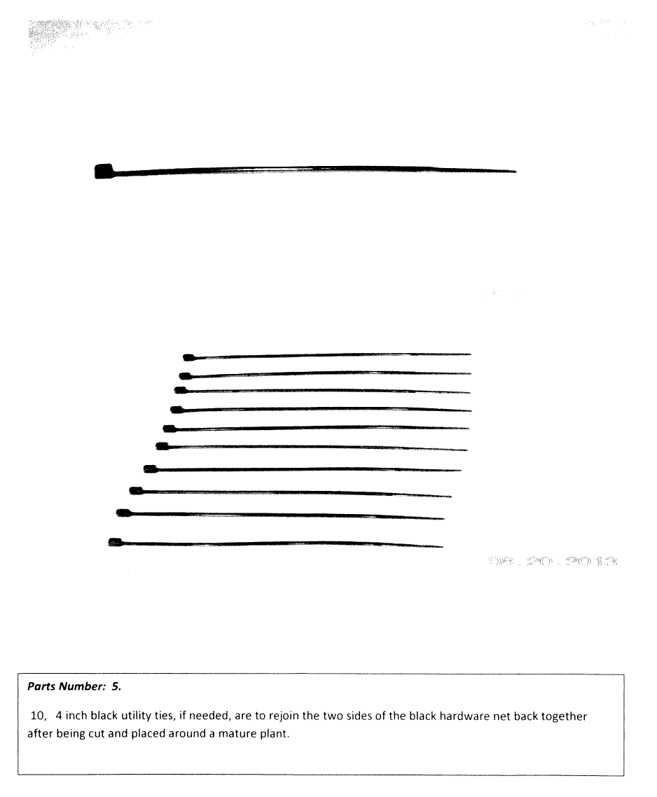

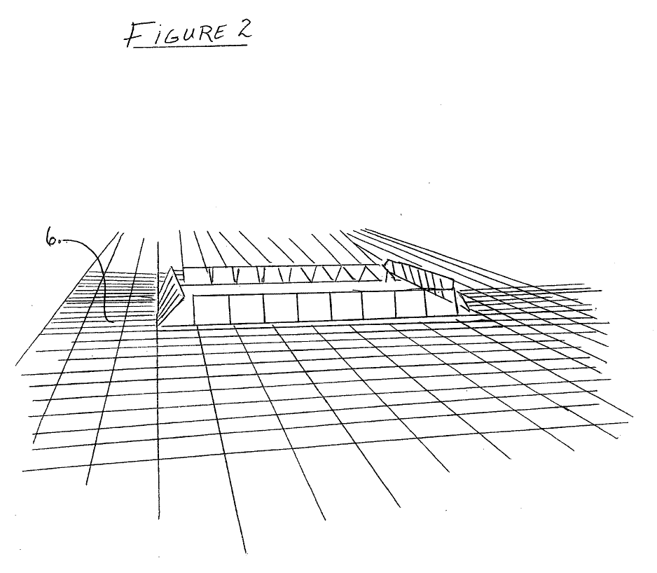

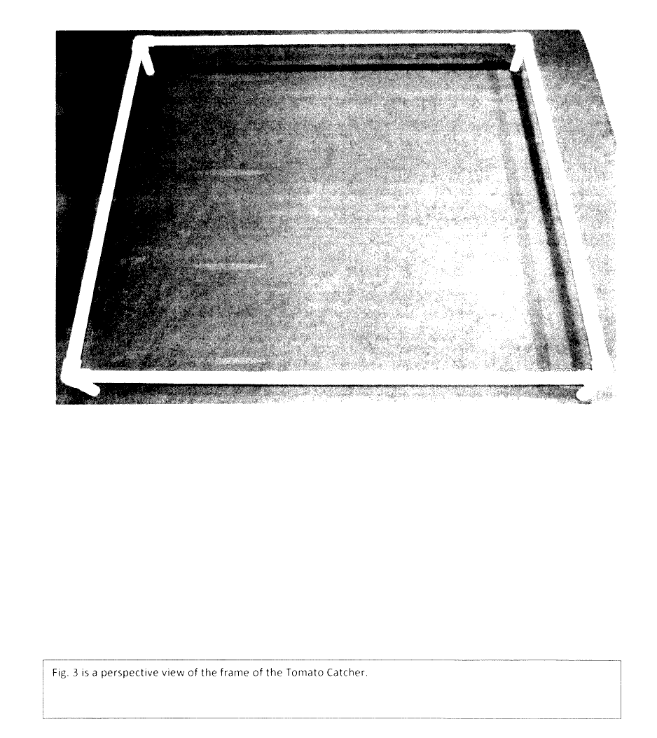

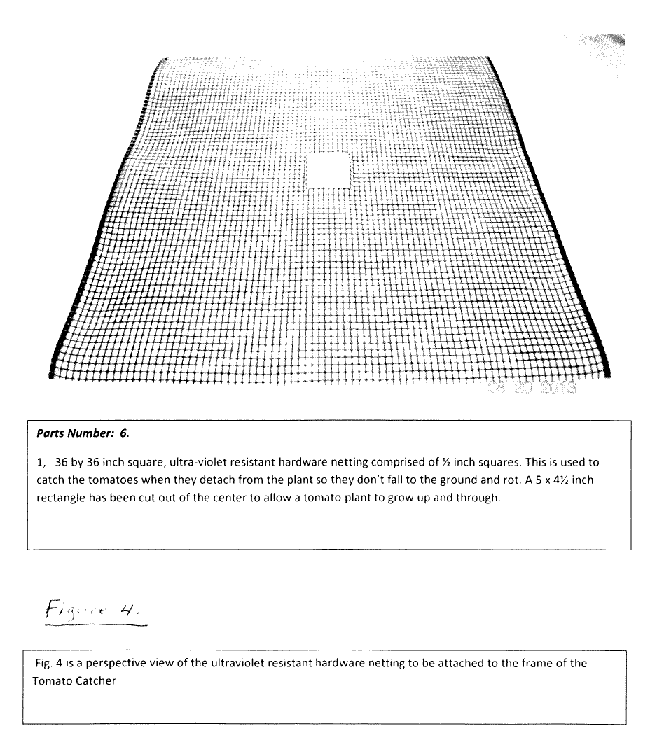

Referring to the invention in more detail, the Tomato Catcher device consists of a 36×36 inch square plastic ultra-violet resistant netting (FIG. 4) comprised of ½ inch squares with one 5×4½ inch rectangle cut out of the center to plant a tomato plant through and into the soil. (FIG. 1) Said rectangle is surrounded by four, 1 inch flanges that will rest against the tomato plant to help shield the tomatoes from falling through the center hole near the plant and onto the ground thereby rotting. (FIGS. 2, 4 and 5)

The above plastic netting is attached on all four sides to the bottom of four 34′A inch diameter PVC (Polyvinyl Chloride) tubes using 6 inch utility ties spaced at approximately 5 inch intervals. (FIG. 1, Parts 1-5) At the ends of each corner, ½ inch PVC tubes are inserted into both horizontal sides of a ½ inch side outlet elbow. (FIG. 1, Parts 2 & 3) In addition, four ½×4 inch PVC tubes are inserted into each vertical opening of the ½ inch side outlet elbows to establish the four legs for which the Tomato Catcher stands on. (FIG. 1, Part 3)

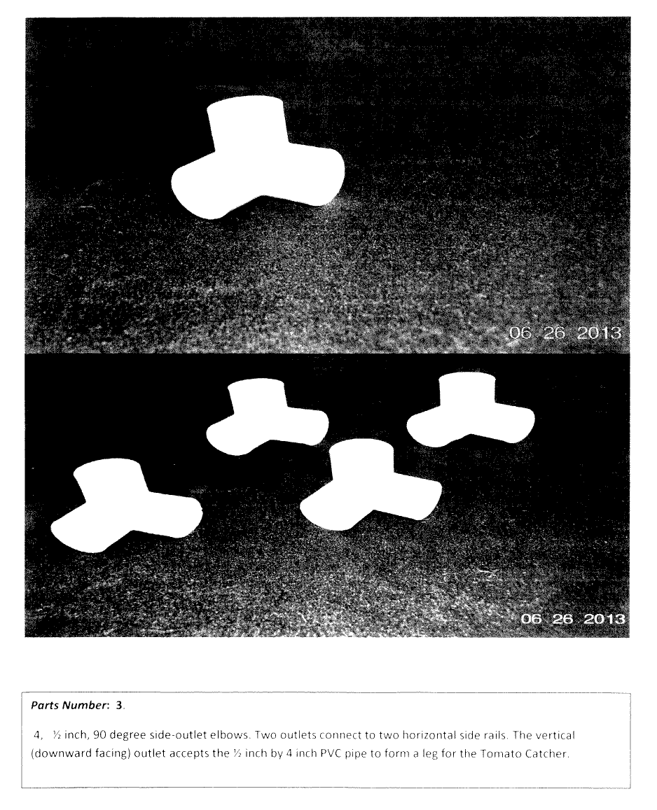

FIG. 3 drawing is a perspective view of the assembled 36×36 inch square PVC tubing with 4 legs attached.

FIG. 4 drawing is a perspective view of the 36×36 inch square ultra-violet resistant netting to be attached to the frame depicted in FIG. 3, indicating a 5×4½ inch rectangular cut-out in the center to which to allow a tomato plant or cucumber plant to grow up and through.

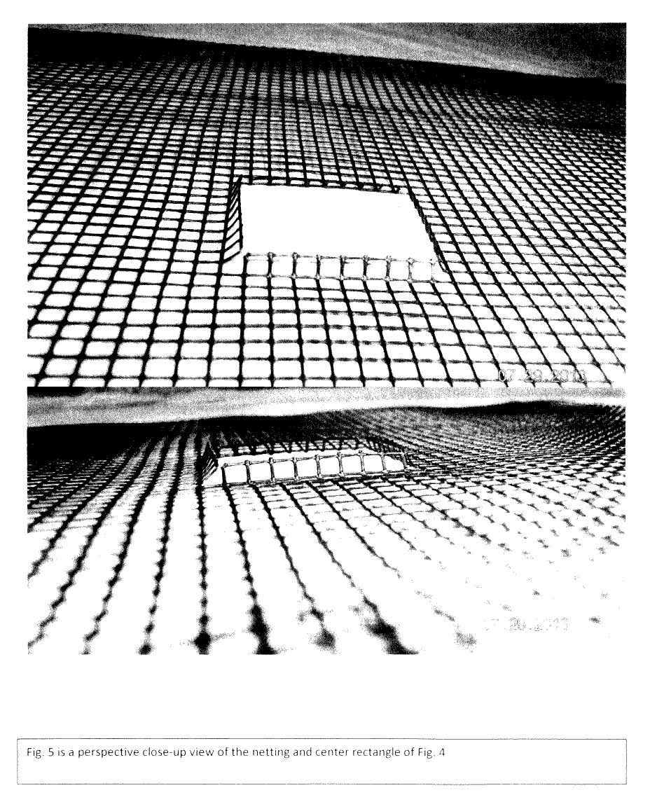

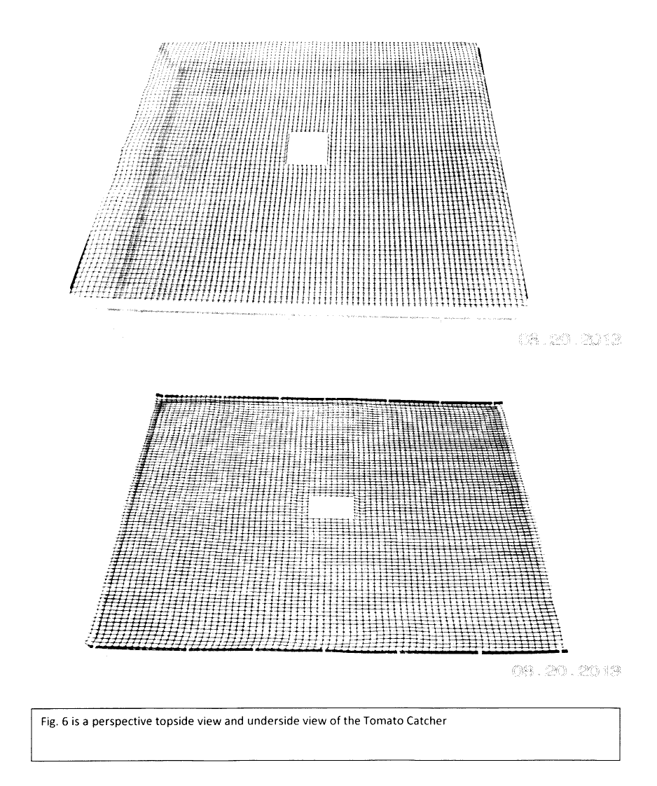

FIG. 6 is a perspective topside and bottomside view of the assembled frame and netting.

FIG. 7 is a perspective side view of the assembled device which shows the topside net clearance from the ground at approximately 4 inches.

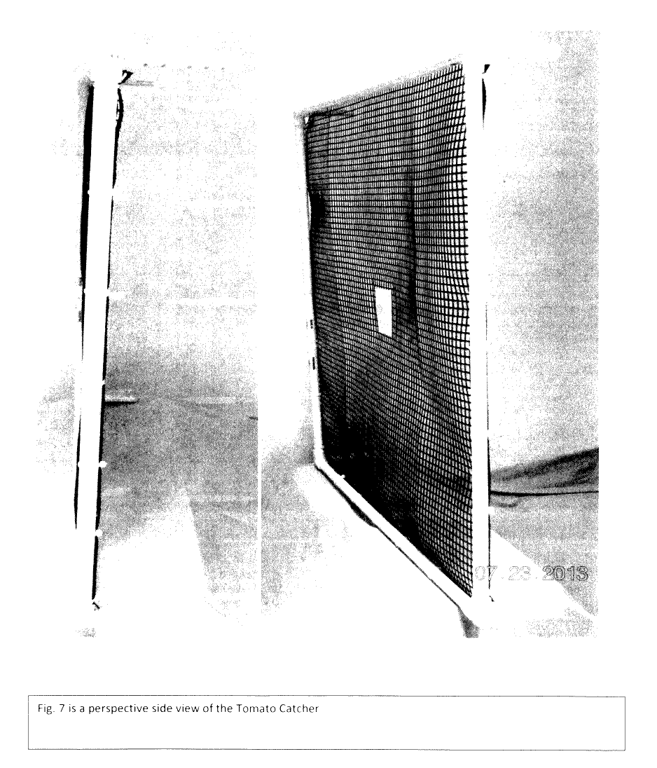

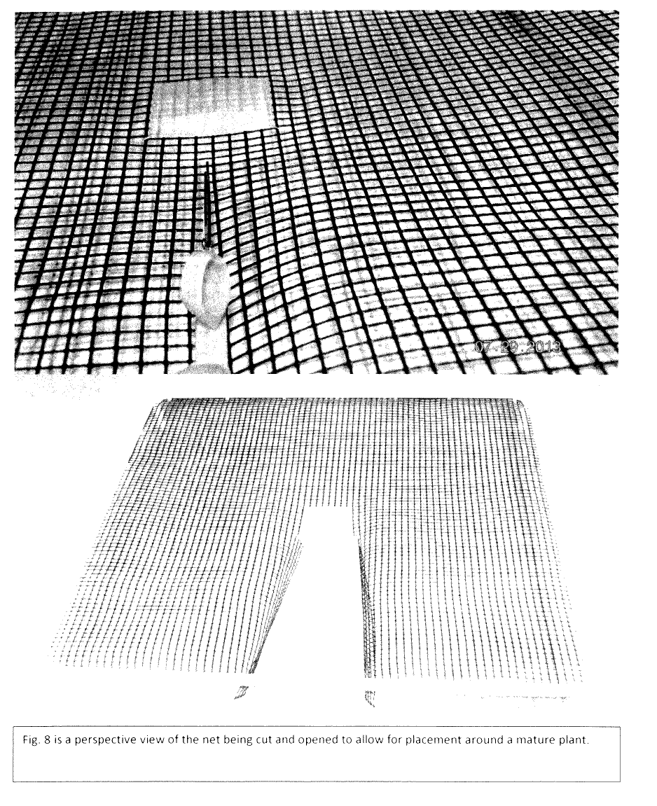

FIG. 8 is a perspective view of the net being cut and opened in order for placement of the invention around a tomato or cucumber plant. The instructions provided for making this cut and opening are as follows:

Locate the black utility tie on one side rail. The black utility tie indicates the row you will be cutting up through to the center hole to allow placement of the Tomato Catcher around your preexisting plant. Using the black utility tie as a row marker, begin cutting up through this row. Once you reach the center cutout, return to the black utility tie, cutting the tie and the mesh edge under the rail where the tie was. Now you can spread open the mesh enough to place the Tomato Catcher around your existing adult plant. Use the enclosed black utility ties to secure the cut edge of the netting back together, placing a tie approximately every 1½ inches. Replace the black indicator utility tie with two white utility ties to secure each side of the cut mesh to the side rail. Enclosed you will find 10 black and 2 white utility ties for use in securing your Tomato Catcher around existing plants.

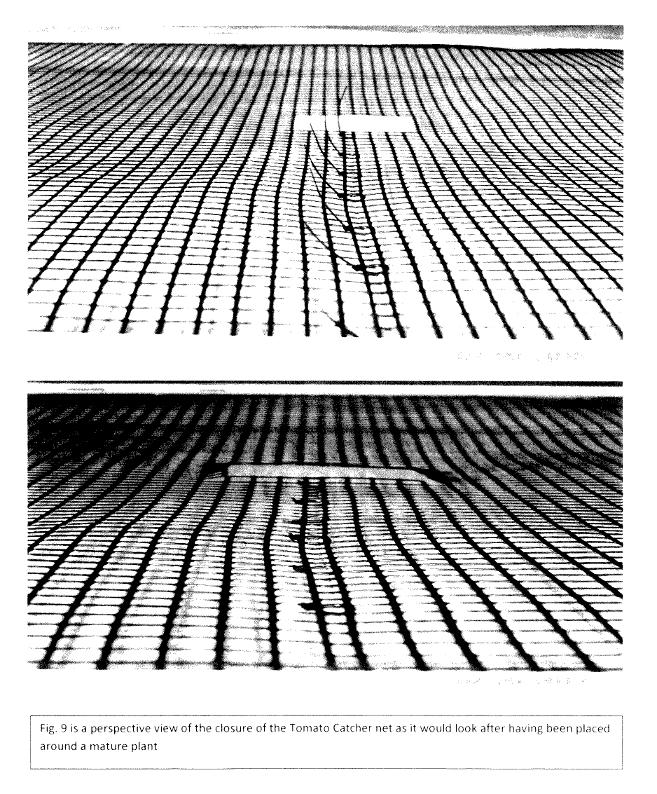

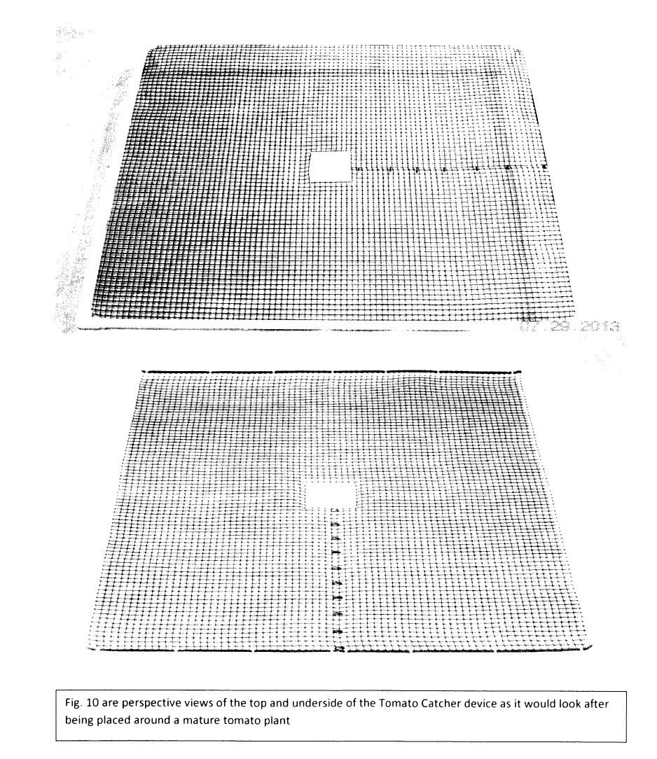

FIGS. 9 and 10 are perspective views of the closure of the Tomato Catcher net as it would look after having been placed around a mature plant.

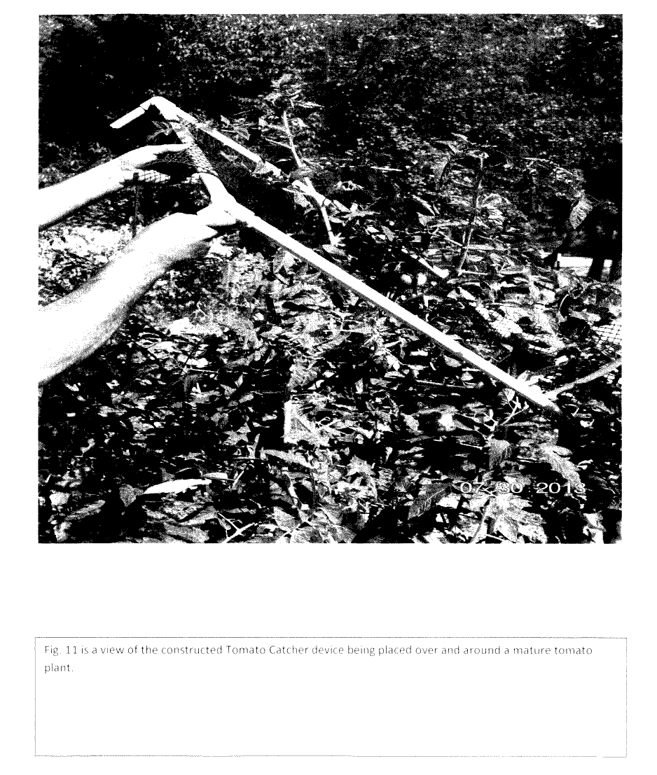

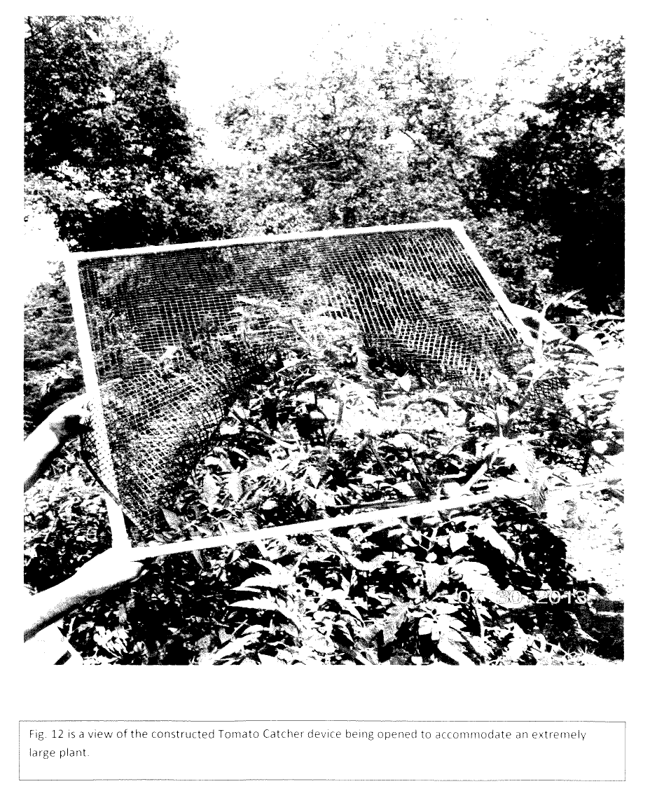

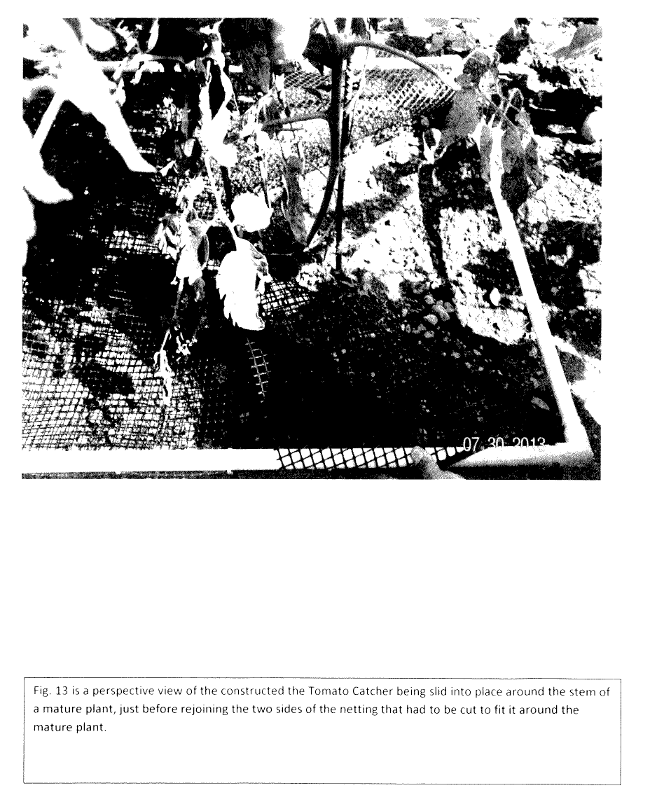

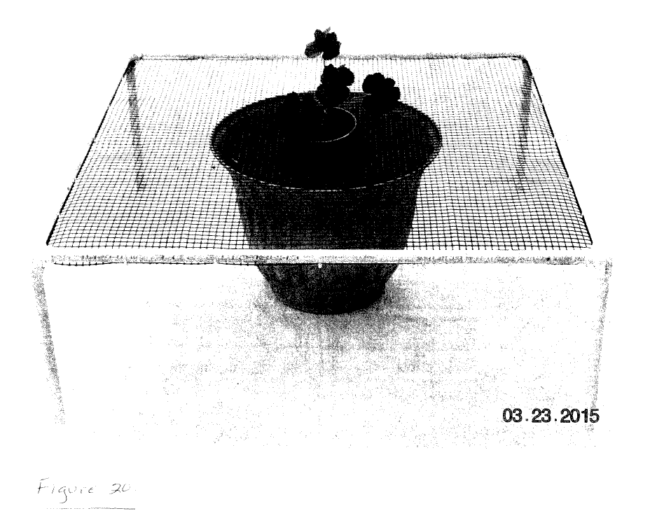

Once assembled, the method of placement of the device around the tomato or cucumber plant may vary, depending upon the size and location of the plant. FIG. 11 illustrates how the device is placed over and around a mature tomato plant. For an extremely large plant, the device can be opened sufficiently to accommodate a larger circumference by removing the ties which secure the netting to the frame, and then resecuring the netting once in place and around the plant as shown in FIG. 13. For a potted plant, the device can be adapted by using longer legs as illustrated in FIG. 20.

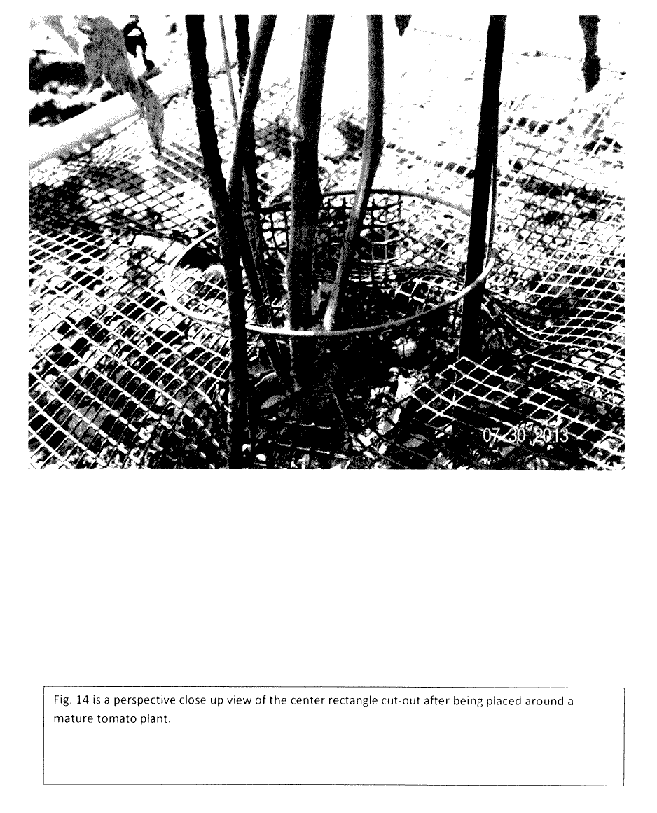

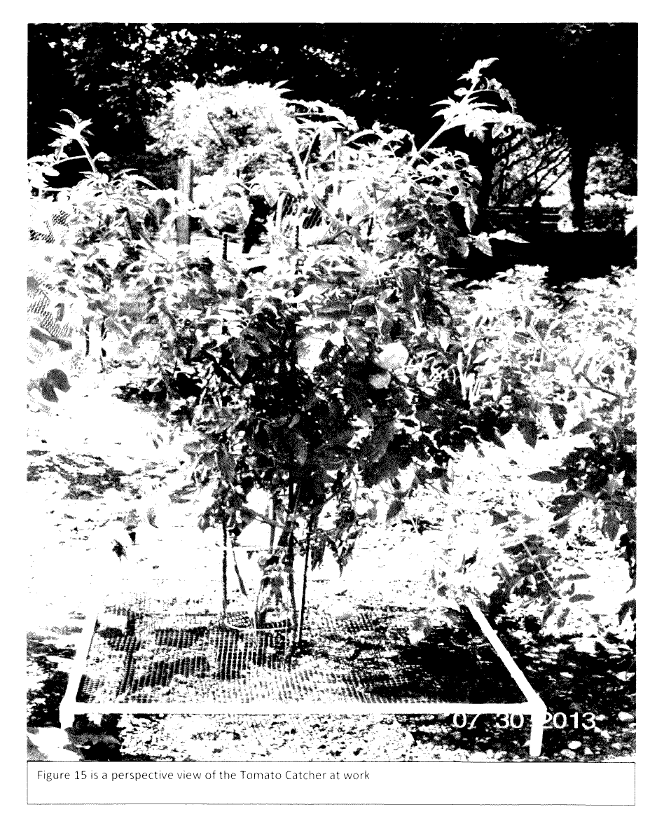

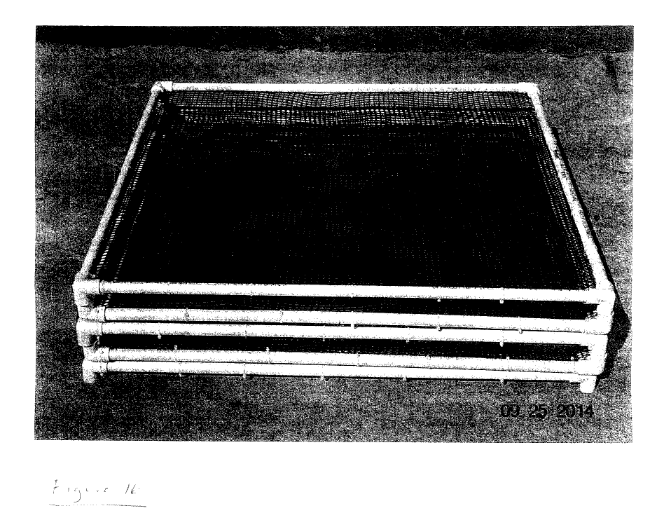

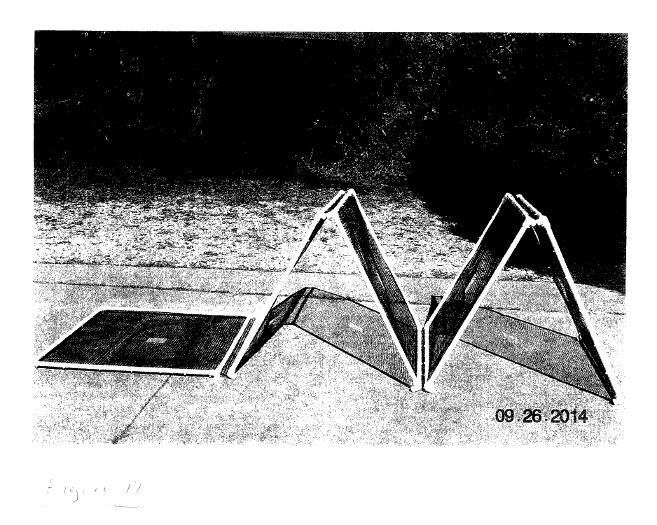

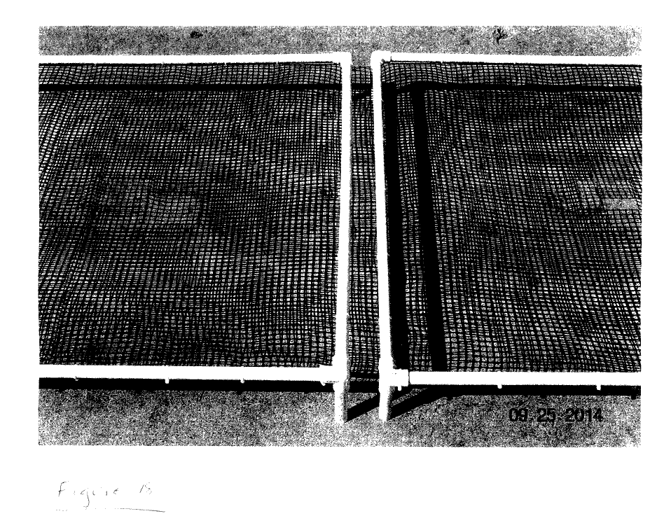

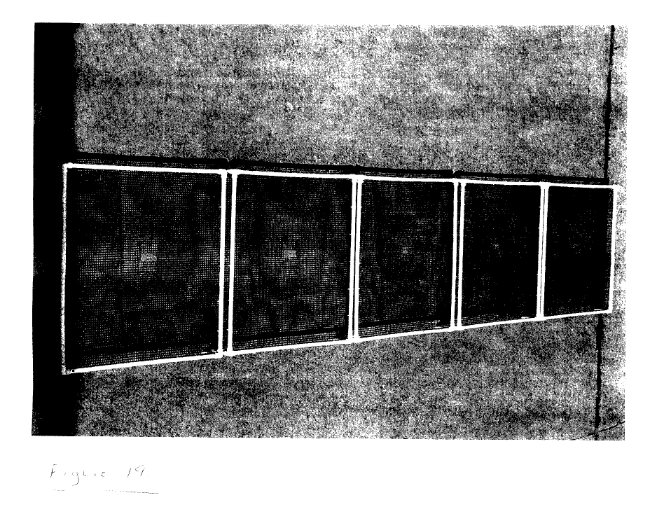

The fully assembled Tomato Catcher device at work around a mature tomato plant is shown in FIG. 15, as a singular placed device. For an expansion of this device to be placed around multiple plants laying side by side, the Tomato Catcher invention will also be produced comprising five (5) connective Tomato Catchers which fold together and stack on each other. (FIGS. 16, 17, 18 & 19).

What is claimed is:

1. A tomato catcher device used to harvest and catch the produce of a tomato plant or cucumber plant, thereby preventing said produce from falling to the ground and rotting, comprising:
a plurality of plastic tubing as a supportive frame that is formed into a rectangle with corner elbows;
a plurality of tube legs attached to the underside of said tubular frame platform, said legs being of sufficient length to keep net approximately four inches off the ground soil or of sufficient length to be placed over a standing potted plant;
a net with a center hole to accommodate the stem of a growing plant; further comprising a plurality of ventilation apertures to catch and protect falling plant produce;
a tying means of attaching the net to the rectangular platform;
a means of attaching five tomato catcher devices which allow said devices to be placed side by side and/or folded and stacked for storage.

2. The Tomato Catcher recited in claim 1 wherein ½ inch by 34½ inch long PVC tubes used to construct the horizontal side rails of the rectangular frame.

3. The Tomato Catcher recited in claim 1 wherein ½ inch by 4 inch PVC tubes used to connect the 4 legs to the rectangular frame.

4. The Tomato Catcher recited in claim 1 wherein ½ inch, 90 degree PVC elbows connect the side rails of the frame and connect the legs.

5. The Tomato Catcher recited in claim 1 wherein the net consists of a 36×36 in. square plastic ultra-violet resistant material, comprised of plurality of ½ inch squares, with one 5×4½ in. rectangular cut out of the center surrounded by four 1 inch flanges.

6. The Tomato Catcher recited in claim 1 wherein the net is secured to the device support frame thirty 6 inch utility ties spaced at approximately five inch intervals.

7. The Tomato Catcher recited in claim 1 wherein said net having sufficient openings to provide ventilation and drainage and to be of sufficient strength to hold the fallen produce.

8. A method for increasing the yield of undamaged tomatoes and cucumbers and certain other fruits and vegetables by reducing the incidence of spoilage comprising the steps of
a. providing a tubular and rectangular support frame to attach and hold a 36×36 inch square plastic ultra-violet resistant black net material comprised of ½ inch squares with one 5×4½ rectangular cut-out in center with 1 inch flanges, securing said net to the frame with 6 inch utility ties;
b. securing said net to the frame with 6 inch utility ties;
c. providing for the device placement around the plant by the cutting and opening of the net from outer edge to the rectangular center cut-out and then securing said net around the plant with utility ties;
d. keeping fallen fruits and vegetables from falling to the ground, thereby preventing spoilage before harvesting.

9. Tomato Catcher device recited in claim 1 with a plurality of said devices attached horizontally, thereby catching and harvesting the produce of multiple tomato plants or cucumber plants in a row comprising:
a plurality of Tomato Catcher devices attached by one resistant black net material approximately 15.5 feet in length and approximately 3 feet in width;
a net spaced in between each tomato catcher device which is flexible to provide for folding and stacking of each device.
